(19) United States
(12) Patent Application Publication
(10) Pub. No.: US 2014/0087020 A1
(43) Pub. Date: Mar. 27, 2014

(54) THICK TEXTURED ACIDIFIED DAIRY OR DAIRY-LIKE PRODUCTS AND METHODS FOR PRODUCING SAME

(71) Applicant: NESTEC S.A., Vevey (CH)

(72) Inventors: Andreas Manfred LINSENMEIER, Dittenheim (DE); Frank Andre STORR, Bad Nauheim (DE); Mathilde HALLE, Konstanz (DE)

(21) Appl. No.: 14/025,817

(22) Filed: Sep. 12, 2013

(30) Foreign Application Priority Data
Sep. 12, 2012 (US) 61699931

(51) Int. Cl. A23C 9/156

(52) U.S. Cl. CPC A23C 9/156
USPC 426/2; 426/580

(57) ABSTRACT

The present disclosure provides shelf stable dairy based compositions having a thick texture while also satisfying nutritional requirements for babies and young children and methods for producing the same. Methods of thickening dairy based compositions are also provided. In a general embodiment, the present disclosure provides a method for producing a shelf stable dairy based nutritional composition by providing a dairy based composition and a specially formulated fruit or flavor preparation to create a thickened dairy based nutritional composition through direct acidification having textures and nutritional components that are appealing to children.

### BACKGROUND

The present disclosure relates generally to health and nutrition. More specifically, the present disclosure relates to shelf stable acidified dairy or dairy-like nutritional compositions with a thickened texture adapted to the nutritional needs of young children. Methods for producing the nutritional compositions through direct acidification are also provided.

There are many types of nutritional compositions currently on the market. Nutritional compositions can be targeted toward certain populations or consumer groups, for example, young, elderly, athletic, etc., based on the specific foods and/or other ingredients in the nutritional composition. It is important to provide well-rounded and nutritious diets to growing young children (e.g., babies and toddlers) to help them meet their daily micro- and macro-nutrient requirements, while limiting the intake of certain nutrients. However, taste and texture are extremely important in getting young children to consume nutritious foods.

One goal of nutritional support, therefore, is to provide young children with developmentally appropriate nutritional compositions such as dairy or dairy like products with pleasing textures, while also providing the nutritional requirements needed in a child's daily diet. Another goal of nutritional support is to provide manufacturing methods for producing dairy or dairy-like products having a thickened texture through a direct acidification process

### SUMMARY

Shelf stable dairy based nutritional compositions with a thickened texture are provided. Methods of producing dairy based nutritional compositions with a thickened texture are also provided. In a general embodiment, the methods include making a dairy based nutritional composition by acidifying a high pH dairy based composition with a low pH preparation, causing a thickening of the composition to occur.

In another embodiment, the methods include providing a shelf stable dairy based composition, a low pH fruit or flavor preparation, mixing the dairy based composition and the fruit or flavor preparation, causing a thickening of the composition; and, depositing the composition into packaging, and allowing post-thickening of the composition to occur.

In an embodiment, the dairy based composition is not fermented. It may include a dairy ingredient selected from the group consisting of cow's milk, sheep's milk, goat's milk, non-fermented cheese, cream, butter, or combinations thereof.

In an embodiment, the dairy based composition is a dairy-substitute. It may include a dairy-substitute ingredient selected from the group consisting of rice milk, soy milk, coconut milk, almond milk, nut milk, or combinations thereof.

In an embodiment, the dairy based composition is heat treated. In an embodiment, the dairy based composition is acidified after heat treatment.

In an embodiment, the fruit or flavor preparation and dairy based composition include hydrocolloids. The hydrocolloids may be pectin, carrageenan, gelatin, guar gum, tapioca, starches, or combinations thereof. The hydrocolloids interact, thickening the composition.

In an embodiment, the dairy based composition includes milk, sugar starch and hydrocolloids.

In an embodiment, the dairy based composition and the fruit or flavor preparation have lower viscosities than the viscosity of the final thickened nutritional composition.

In an embodiment, the preparation is a fruit preparation that includes at least one fruit component selected from the group consisting of apple, banana, mango, orange, tangerine, tangelo, grapefruit, lemon, lime, grape, passionfruit, cherry, berry, raspberry, blackberry, boysenberry, mulberry, strawberry, blueberry, goji berry, currant, acai, peach, nectarine, plum, apricot pineapple, guava, kiwi, cherimoya, kumquat, lychee, pitaya, jackfruit, melon, pear, mangosteen, pomegranate, or combinations thereof.

In an embodiment, the preparation is a non-fruit flavor preparation including at least one component selected from the group consisting of vanilla, chocolate, coffee, caramel, butterscotch, mint, spice, nut, ginger, cinnamon, or combinations thereof.

In an embodiment, the fruit or flavor preparation has a pH less than 7. In an embodiment, the preparation has pH of about 4-4.5.

In an embodiment, the preparation includes fruit, sugar, hydrocolloids, and organic acid.

In an embodiment, the preparation is aseptic. The preparation may also be pasteurized or sterilized.

In an embodiment, the preparation contains an acidulant. The acidulant may be selected from the group consisting of organic acid, lactic acid, malic acid, citric acid, calcium citrate, tartaric acid, phosphoric acid, glucono delta lactone, or combinations thereof.

In an embodiment, the composition includes at least one ingredient selected from the group consisting of a source of carbohydrate, a source of fat, canola oil, flaxseed oil, a source of omega-3 fatty acids, a source of protein, a source of fiber, a flavor, a color, a vegetable puree, vitamins, minerals, DHA, EPA, antioxidants, amino acids, fish oil, phytochemicals, probiotics, prebiotics, synbiotics, non-replicating microorganism, liquid whole grain, or combinations thereof.

In an embodiment, the method includes hot filling the nutritional composition at a temperature ranging from about 50° to about 80° C. and includes post-setting in the final packaging.

In an embodiment, the method includes UHT processing of the nutritional composition. In an embodiment, the method includes aseptic dosing of the dairy based composition and the preparation. In an embodiment, the method includes sterilization of the dairy based composition. In an embodiment, the method includes pasteurization processing of the nutritional composition.

In an embodiment, the method further includes acidification of the dairy based composition through continuous mixing of the dairy based composition and the preparation. The mixing may occur at a low temperature.

In an embodiment, the composition includes macronutrients and micronutrients tailored to the nutritional needs of babies and toddlers up to about 36 months of age. In an embodiment, the macronutrients and micronutrients are tailored to the nutritional needs of babies 6-36 months of age, or 12-18 months of age.

In an embodiment, the composition includes calcium, magnesium, and zinc.

In an embodiment, the composition includes a protein content tailored to the nutritional needs of babies and toddlers.

In an embodiment, the fruit or flavor preparation is mixed with the dairy based composition immediately before depositing the nutritional composition into the packaging.

In an embodiment, the nutritional composition is thickened to a texture pleasing to children of about 6 to 36 months of age, or 12 to 18 months of age.

In an embodiment, the nutritional composition is thickened to a jellified texture. The texture may also be a smooth, homogenous texture.

In an embodiment, the nutritional composition is deposited in packaging. The method includes post-thickening in the final packaging.

In an embodiment, the packaging is aesthetically appealing to children and their caregivers. In an embodiment, the packaging is of an appropriate size and shape for a child beginning to self-feed.

In an embodiment, the nutritional composition has a pH of about 4 to 4.5. In an embodiment, the nutritional composition has a pH less than 7.

In an embodiment, the nutritional composition is shelf-stable at ambient temperatures. The nutritional composition may be shelf stable up to 9 months.

In another embodiment, a method of making a new shelf stable dairy based nutritional composition using existing manufacturing lines is provided. The method includes providing a shelf stable, pH neutral, dairy based composition, providing a low pH fruit preparation, mixing the dairy based composition and the fruit preparation, and creating a nutritional composition with a greater viscosity than the viscosity of either the dairy based composition or the fruit preparation.

In an embodiment, the fruit preparation includes at least one fruit component selected from the group consisting of apple, banana, mango, orange, tangerine, tangelo, grapefruit, lemon, lime, grape, passionfruit, cherry, berry, raspberry, blackberry, boysenberry, mulberry, strawberry, blueberry, goji berry, currant, acai, peach, nectarine, plum, apricot pineapple, guava, kiwi, cherimoya, kumquat, lychee, pitaya, jackfruit, melon, pear, mangosteen, pomegranate, or combinations thereof.

In an embodiment, the method includes providing a non-fruit flavor component selected from the group consisting of vanilla, chocolate, coffee, caramel, butterscotch, mint, spice, nut, ginger, cinnamon, or combinations thereof.

In an embodiment, the fruit preparation directly acidifies the dairy based composition.

In an embodiment, mixing the dairy based composition and the fruit preparation triggers a post-thickening effect.

In an embodiment, the viscosity of the nutritional compositions does not build up until the final stages of the manufacturing process.

In an embodiment, the composition is manufactured without modifying the existing manufacturing lines.

In an embodiment, the method has a lower production time and cost than other methods for producing high viscosity nutritional compositions.

In an embodiment, the composition has a high viscosity pleasing to children of about 6-36 months of age. In an embodiment, the high viscosity is pleasing to children of about 12-18 months of age.

In an embodiment, the nutritional composition provides new tastes and textures for babies and young children.

In yet another embodiment, a method of providing nutrition to young children beginning to self-feed is provided. The method includes producing a nutritional product by mixing a pH neutral, dairy based composition comprising nutrients for child development with a low pH flavor preparation, thereby causing a thickening of the composition, depositing the composition into packaging and allowing post-thickening to occur, and marketing the nutritional product for ingestion by a target market comprising young children.

In still yet another embodiment, a method of promoting growth and development of a child is provided. The method includes producing a thick, shelf stable dairy based nutritional product by mixing a pH neutral, dairy based composition and a low pH flavor preparation comprising nutrients for child development, thereby causing a thickening of the composition, depositing the nutritional composition into packaging, and allowing post-thickening of the composition to occur, and, providing the thick, shelf stable dairy based nutritional product to a child based on age and a developmental stage of the child.

In an embodiment, the dairy based composition is not fermented. It may include a dairy ingredient selected from the group consisting of cow's milk, sheep's milk, goat's milk, non-fermented cheese, cream, butter, or combinations thereof.

In an embodiment, the dairy based composition is a dairy-substitute. It may include a dairy-substitute ingredient selected from the group consisting of rice milk, soy milk, coconut milk, almond milk, nut milk, or combinations thereof.

In an embodiment, the dairy based composition is heat treated. In an embodiment, the dairy based composition is acidified after heat treatment.

In an embodiment, the fruit or flavor preparation and dairy based composition include hydrocolloids. The hydrocolloids may be pectin, carrageenan, gelatin, guar gum, tapioca, starches, or combinations thereof. The hydrocolloids interact, thickening the composition.

In an embodiment, the dairy based composition includes milk, sugar starch and hydrocolloids.

In an embodiment, the dairy based composition and the fruit preparation have lower viscosities than the viscosity of the final thickened nutritional product.

In an embodiment, the preparation is a fruit preparation that includes at least one fruit component selected from the group consisting of apple, banana, mango, orange, tangerine, tangelo, grapefruit, lemon, lime, grape, passionfruit, cherry, berry, raspberry, blackberry, boysenberry, mulberry, strawberry, blueberry, goji berry, currant, acai, peach, nectarine, plum, apricot pineapple, guava, kiwi, cherimoya, kumquat, lychee, pitaya, jackfruit, melon, pear, mangosteen, pomegranate, or combinations thereof.

In an embodiment, the preparation is a non-fruit flavor preparation including at least one component selected from the group consisting of vanilla, chocolate, coffee, caramel, butterscotch, mint, spice, nut, ginger, cinnamon, or combinations thereof.

In an embodiment, the fruit or flavor preparation has a pH less than 7. In an embodiment, the preparation has pH of about 4-4.5.

In an embodiment, the preparation includes fruit, sugar, hydrocolloids, and organic acid.

In an embodiment, the preparation is aseptic. The preparation may also be pasteurized or sterilized.

In an embodiment, the preparation contains an acidulant. The acidulant may be selected from the group consisting of organic acid, lactic acid, malic acid, citric acid, calcium citrate, tartaric acid, phosphoric acid, glucono delta lactone, or combinations thereof.

In an embodiment, the method further includes providing at least one ingredient selected from the group consisting of a source of carbohydrate, a source of fat, canola oil, flaxseed oil, a source of omega-3 fatty acids, a source of protein, a source of fiber, a flavor, a color, a vegetable puree, vitamins, minerals, DHA, EPA, antioxidants, amino acids, fish oil, phytochemicals, probiotics, prebiotics, synbiotics, non-replicating microorganism, liquid whole grain, or combinations thereof.

In an embodiment, the method includes hot filling the nutritional composition at a temperature ranging from about 50° to about 80° C. and includes post-setting in the final packaging.

In an embodiment, the method includes UHT processing of the nutritional composition. In an embodiment, the method includes aseptic dosing of the dairy based composition and the preparation. In an embodiment, the method includes sterilization of the dairy based composition.

In an embodiment, the method further includes acidification of the dairy based composition through continuous mixing of the dairy based composition and the preparation. The mixing may occur at a low temperature.

In an embodiment, the flavor preparation is mixed with the dairy based composition immediately before depositing the nutritional product into the packaging.

In an embodiment, the preparation directly acidifies the dairy based composition.

In an embodiment, the method includes providing macronutrients and micronutrients tailored to the nutritional needs of babies and toddlers up to about 36 months of age. In an embodiment, the macronutrients and micronutrients are tailored to the nutritional needs of babies 6-36 months of age, or 12-18 months of age.

In an embodiment, the nutrients for child development are the nutrients required for healthy growth by children at the developmental stage selected from the group consisting of supported sitter, sitter, crawler, toddler, preschooler, or combinations thereof.

In an embodiment, the method includes providing calcium, magnesium, and zinc. The nutritional product may provide at least 45% of young children's daily requirement for calcium, magnesium and zinc. In an embodiment, iron is also provided.

In an embodiment, the method includes providing protein content tailored to the nutritional needs of children at the developmental stage selected from the group consisting of supported sitter, sitter, crawler, toddler, preschooler, or combinations thereof.

In an embodiment, the fruit or flavor preparation is mixed with the dairy based composition immediately before depositing the nutritional product into the packaging.

In an embodiment, the nutritional product is thickened to a texture pleasing to children of about 6 to 36 months of age, or 12 to 18 months of age.

In an embodiment, the nutritional product is thickened to a jellified texture. The texture may also be a smooth, homogenous texture.

In an embodiment, ingestion of the nutritional composition marketed to the target market comprising young children exposes the target market to new textures and flavors.

In an embodiment, the packaging is aesthetically appealing to children and their caregivers. In an embodiment, the packaging is of an appropriate size and shape for a child beginning to self-feed. In an embodiment, the packaging includes indicia regarding the age and development stage of the target market for the nutritional product. The packaging can also include colors corresponding to the flavors of the nutritional product.

In an embodiment, the packaging includes enough of the nutritional product to be an appropriate size snack for a child. In an embodiment, the packaging includes enough of the nutritional product to be an appropriate size meal for child. In an embodiment, the packaging includes enough of the nutritional product to be an appropriate size dessert for a child.

In an embodiment, the nutritional composition has a pH of about 4, or about 4.5, or less than 7.

In yet another embodiment, a shelf stable, dairy based nutritional composition is provided. The composition includes a dairy based composition, and a low pH flavor preparation, with the dairy based having been directly acidified by the flavor preparation to yield a thick textured nutritional composition.

In an embodiment, the dairy based composition is not fermented. It may include a dairy ingredient selected from the group consisting of cow's milk, sheep's milk, goat's milk, non-fermented cheese, cream, butter, or combinations thereof.

In an embodiment, the dairy based composition is a dairy-substitute. It may include a dairy-substitute ingredient selected from the group consisting of rice milk, soy milk, coconut milk, almond milk, nut milk, or combinations thereof.

In an embodiment, the flavor preparation and the dairy based composition include hydrocolloids. In an embodiment, they are selected from the group consisting of pectin, carrageenan, guar gum, tapioca, starches, or combinations thereof. In an embodiment, the hydrocolloids interact, thickening the nutritional composition.

In an embodiment, the dairy based composition is heat treated. In an embodiment, the dairy based composition is acidified after heat treatment.

In an embodiment, the dairy based composition is pH neutral.

In an embodiment, the dairy based composition includes milk, sugar, starch, and hydrocolloids.

In an embodiment, the dairy based composition and the flavor preparation have lower viscosities than the viscosity of the final thickened nutritional composition.

In an embodiment, the flavor preparation is a fruit preparation that includes at least one fruit component selected from the group consisting of apple, banana, mango, orange, tangerine, tangelo, grapefruit, lemon, lime, grape, passionfruit, cherry, berry, raspberry, blackberry, boysenberry, mulberry, strawberry, blueberry, goji berry, currant, acai, peach, nectarine, plum, apricot pineapple, guava, kiwi, cherimoya, kumquat, lychee, pitaya, jackfruit, melon, pear, mangosteen, pomegranate, or combinations thereof.

In an embodiment, the flavor preparation is a non-fruit flavor preparation including at least one component selected from the group consisting of vanilla, chocolate, coffee, caramel, butterscotch, mint, spice, nut, ginger, cinnamon, or combinations thereof.

In an embodiment, the preparation has a pH less than 7. In an embodiment, the preparation has pH of about 4-4.5.

In an embodiment, the preparation includes fruit, sugar, hydrocolloids, and organic acid.

In an embodiment, the preparation is aseptic. The preparation may also be pasteurized or sterilized.

In an embodiment, the preparation contains an acidulant. The acidulant may be selected from the group consisting of organic acid, lactic acid, malic acid, citric acid, calcium citrate, tartaric acid, phosphoric acid, glucono delta lactone, or combinations thereof.

In an embodiment, the composition further includes providing at least one ingredient selected from the group consisting of a source of carbohydrate, a source of fat, canola oil, flaxseed oil, a source of omega-3 fatty acids, a source of protein, a source of fiber, a flavor, a color, a vegetable puree, vitamins, minerals, DHA, EPA, antioxidants, amino acids, fish oil, phytochemicals, probiotics, prebiotics, synbiotics, non-replicating microorganism, liquid whole grain, or combinations thereof.

In an embodiment, the composition includes providing calcium, magnesium, and zinc. The composition may also include iron. In an embodiment, the composition includes modified starches.

In an embodiment, the composition is a low or no-sugar composition. It may also be free of artificial flavors, colors, and preservatives.

In an embodiment, the nutritional composition is a low acidity (high pH) composition.

In an embodiment, the composition has the texture of curd, but a distinct nutritional profile. In an embodiment, the composition has a lower protein content than standard chilled dairy products.

In an embodiment, the nutritional composition is thickened to a jellified texture. In an embodiment, the composition has a smooth, homogenous texture.

In an embodiment, the composition is a snack. In an embodiment, the composition is a whole meal. In an embodiment, the composition is part of a meal. In an embodiment, the composition is a dessert.

In an embodiment, the composition includes protein content tailored to the nutritional needs at the appropriate developmental stage selected from the group consisting of supported sitter, sitter, crawler, toddler, preschooler, or combinations thereof.

In an embodiment, the nutritional composition has a pH of about 4. In an embodiment, the pH is about 4.5. In an embodiment, the pH of the nutritional composition is less than 7.

In another embodiment, a shelf stable, dairy based nutritional composition designed to provide nutritional support to young children is provided. The composition includes a dairy based composition, a low pH flavor preparation, and macronutrients and micronutrients tailored to the nutritional needs of young children. The dairy based composition is directly acidified by the flavor preparation to yield a thick textured nutritional composition.

In an embodiment, the nutritional composition further comprises a macronutrient and micronutrient content tailored to the nutritional needs of children aged 6 to 36 months. In an embodiment, the nutrient content is tailored to the nutritional needs of children aged 12 to 18 months.

In an embodiment, the nutritional composition further comprises a protein content tailored to the nutritional needs of children aged 6 to 36 months.

In an embodiment, the nutritional composition has a portion size suitable to children aged 6 to 36 months.

In an embodiment, the nutritional composition has a thick texture with a thickness that is pleasing to children at the developmental stage selected from the group consisting of supported sitter, sitter, crawler, toddler, preschooler, or combinations thereof.

In an embodiment, the nutritional composition is appropriately sized for consumption by a child at the developmental stage selected from the group consisting of supported sitter, sitter, crawler, toddler, preschooler, or combinations thereof.

An advantage of the present disclosure is to provide a shelf stable dairy or dairy-like product with a thick texture.

Another advantage of the present disclosure is to provide a product with an adapted texture and portion size to help babies start eating alone and develop autonomy.

Yet another advantage of the present disclosure is to provide a dairy or dairy-like product that allows baby and toddler consumers to discover new textures.

Still yet another advantage of the present disclosure is to provide a dairy or dairy-like product that promotes healthy growth and development.

Another advantage of the present disclosure is to provide a product that includes calcium, magnesium, and zinc for bone development and normal bone growth.

Yet another advantage is to provide methods of making shelf stable dairy or dairy-like compositions with a thickened texture.

Another advantage is to provide method of production that delays viscosity build-up in the manufacturing process.

Yet another advantage is to provide a method of production that yields a higher viscosity final product than the individual viscosities of each phase.

Yet still another advantage is to provide a method of thickening a dairy or dairy-like composition while saving production time and cost as compared to other methods of thickening a composition.

Additional features and advantages are described herein, and will be apparent from the following Detailed Description and the FIGURE.

### BRIEF DESCRIPTION OF THE FIGURES

FIG. 1 illustrates a flow of processes for manufacturing a shelf stable post-thickened dairy or dairy-like product in accordance with an embodiment of the present disclosure.

### DETAILED DESCRIPTION

### Definitions

As used herein, the singular forms “a,” “an” and “the” include plural referents unless the context clearly dictates otherwise. Thus, for example, reference to “a polypeptide” includes a mixture of two or more polypeptides and the like.

As used herein, “about” is understood to refer to numbers in a range of numerals. Moreover, all numerical ranges herein should be understood to include all integer, whole or fractions, within the range.

As used herein, the phrase “acceptable macronutrient distribution range” is meant to include the range of macronutrient intakes associated with reduced risk of chronic disease (and also provides adequate essential nutrients).

As used herein, the phrase “adequate intake” is meant to include the nutrient level believed to cover the nutrient needs of all healthy individuals (goal intake level). However, current data are inadequate to confidently specify the number of individuals covered by this intake level (goal intake level).

As used herein, the phrase “amino acid” is understood to include one or more amino acids. The amino acid can be, for example, alanine, arginine, asparagine, aspartate, citrulline, cysteine, glutamate, glutamine, glycine, histidine, hydroxyproline, hydroxyserine, hydroxytyrosine, hydroxylysine, isoleucine, leucine, lysine, methionine, phenylalanine, proline, serine, taurine, threonine, tryptophan, tyrosine, valine, or combinations thereof.

As used herein, the term “antioxidant” is understood to include any one or more of various substances such as beta-carotene (a vitamin A precursor), vitamin C, vitamin E, and selenium that inhibit oxidation or reactions promoted by Reactive Oxygen Species (“ROS”) and other radical and non-radical species. Additionally, antioxidants are molecules capable of slowing or preventing the oxidation of other molecules. Non-limiting examples of antioxidants include carotenoids, coenzyme Q10 (“CoQ10”), flavonoids, glutathione, Goji (wolfberry), hesperidin, lactowolfberry, lignan, lutein, lycopene, polyphenols, selenium, vitamin A, vitamin B₁, vitamin B₆, vitamin B₁₂, vitamin C, vitamin D, vitamin E, zeaxanthin, or combinations thereof.

As used herein, “carbohydrate(s)” are meant to include Monosaccharides include Trioses (such as: Ketotriose (Dihydroxyacetone); Aldotriose (Glyceraldehyde)); Tetroses which include: Ketotetrose (such as: Erythrulose) and Aldotetroses (such as: Erythrose, Threose); Pentoses which include: Ketopentose (such as: Ribulose, Xylulose) Aldopentose (such as: Ribose, Arabinose, Xylose, Lyxose), Deoxy sugar (such as: Deoxyribose); Hexoses which include: Ketohexose (such as: Psicose, Fructose, Sorbose, Tagatose), Aldohexose (such as: Allose, Altrose, Glucose, Mannose, Gulose, Idose, Galactose, Talose), Deoxy sugar (such as: Fucose, Fuculose, Rhamnose); Heptose (such as: Sedoheptulose); Octose; Nonose (such as: Neuraminic acid); Disaccharides which include: Sucrose; Lactose; Maltose; Trehalose; Turanose; Cellobiose; kojiboise; nigerose; isomaltose; and palatinose; Trisaccharides which include: Melezitose; and Maltotriose; Oligosaccharides which include: corn syrups and maltodextrin; and Polysaccharides which include: glucan (such as dextrin, dextran, beta-glucan), glycogen, mannan, galactan, and starch (such as those from corn, wheat, tapioca, rice, and potato, including Amylose and Amylopectin. The starches can be natural or modified or gelatinized); and combinations thereof. Carbohydrates also include source of sweeteners such as honey, maple syrup, glucose (dextrose), corn syrup, corn syrup solids, high fructose corn syrups, crystalline fructose, juice concentrates, and crystalline juice.

As used herein, “complete nutrition” means nutritional products that contain sufficient types and levels of macronutrients (protein, fats and carbohydrates) and micronutrients to be sufficient to be a sole source of nutrition for the consumer to which it is administered.

As used herein, the term dairy based refers to products that either include dairy products produced from milk, or include dairy-like products produced from milk substitutes such as soy milk, coconut milk, rice milk, nut milk, almond milk, etc.

As used herein, “developmental stage(s)” refers to a stage in a child's life where children typically begin to exhibit certain behaviors or are typically capable of performing certain actions. For example, solid foods are typically introduced to a child in a “Supported Sitter” stage, which may be from about four to about six months of age. Other examples of developmental stages include “Birth+” at about zero to about four months, “Sitter” at about six+ months, “Crawler” at about eight+ months, “Crawler 10+” at about 10 months, “Toddler” at about twelve+ months, and “Preschooler” at about 24+ months.

As used herein, “driving texture attribute” or “key texture attribute” refers to a texture attribute that has a significant impact on distinguishing a food product as being appropriately classified for a particular age or a particular developmental stage. A driving texture attribute may be identified by statistical analysis (e.g., stepwise linear regression analysis, stepwise discriminant analysis, etc.) of a much larger group of texture attributes.

As used herein, “effective amount” is an amount that prevents a deficiency, treats a disease or medical condition in an individual or, more generally, reduces symptoms, manages progression of the diseases or provides a nutritional, physiological, or medical benefit to the individual. A treatment can be patient- or doctor-related.

As used herein, “estimated average requirement” is meant to include the nutrient level expected to meet the needs of 50% of the individuals in an age group.

As used herein, “food grade micro-organisms” means micro-organisms that are used and generally regarded as safe for use in food.

As used herein, “high pH” means a pH greater than 7.0.

As used herein, non-limiting examples of sources of ω-3 fatty acids such α-linolenic acid (“ALA”), docosahexaenoic acid (“DHA”) and eicosapentaenoic acid (“EPA”) include fish oil, krill, poultry, eggs, or other plant or nut sources such as flax seed, walnuts, almonds, algae, modified plants, etc.

As used herein, “meal” food product(s) refers to one or more food products intended to be consumed at normal meal times of breakfast, lunch and dinner.

As used herein, the term “microorganism” is meant to include the bacterium, yeast and/or fungi, a cell growth medium with the microorganism, or a cell growth medium in which microorganism was cultivated.

As used herein, the term “minerals” is understood to include boron, calcium, chromium, copper, iodine, iron, magnesium, manganese, molybdenum, nickel, phosphorus, potassium, selenium, silicon, tin, vanadium, zinc, or combinations thereof.

As used herein, a “non-replicating” microorganism means that no viable cells and/or colony forming units can be detected by classical plating methods. Such classical plating methods are summarized in the microbiology book: James Monroe Jay, et al., “Modern food microbiology,” 7th edition, Springer Science, New York, N.Y. p. 790 (2005). Typically, the absence of viable cells can be shown as follows: no visible colony on agar plates or no increasing turbidity in liquid growth medium after inoculation with different concentrations of bacterial preparations (‘non replicating’ samples) and incubation under appropriate conditions (aerobic and/or anaerobic atmosphere for at least 24 h). For example, bifidobacteria such as Bifidobacterium longum, Bifidobacterium lactis and Bifidobacterium breve or lactobacilli, such as Lactobacillus paracasei or Lactobacillus rhamnosus, may be rendered non-replicating by heat treatment, in particular low temperature/long time heat treatment.

As used herein, “normal bone growth” includes during: childhood and adolescence bones are sculpted by modeling, which allows for the formation of new bone at one site and the removal of old bone from another site within the same bone. This process allows individual bones to grow in size and to shift in space. During childhood bones grow because resorption (the process of breaking down bone) occurs inside the bone while formation of new bone occurs on its outer (periosteal) surface. At puberty the bones get thicker because formation can occur on both the outer and inner (endosteal) surfaces. The remodeling process occurs throughout life and becomes the dominant process by the time that bone reaches its peak mass (typically by the early 20s). In remodeling, a small amount of bone on the surface of trabeculae or in the interior of the cortex is removed and then replaced at the same site. The remodeling process does not change the shape of the bone, but it is nevertheless vital for bone health. Modeling and remodeling continue throughout life so that most of the adult skeleton is replaced about every 10 years. While remodeling predominates by early adulthood, modeling can still occur particularly in response to weakening of the bone.

“Nutritional compositions,” or “nutritional products,” as used herein, are understood to include any number of wholesome food ingredients and possibly optional additional ingredients based on a functional need in the product and in full compliance with all applicable regulations. The optional ingredients may include, but are not limited to, conventional food additives, for example one or more, acidulants, additional thickeners, buffers or agents for pH adjustment, chelating agents, colorants, emulsifies, excipient, flavor agent, mineral, osmotic agents, a pharmaceutically acceptable carrier, preservatives, stabilizers, sugar, sweeteners, texturizers, and/or vitamins. The optional ingredients can be added in any suitable amount.

As used herein, “phytochemicals” or “phytonutrients” are non-nutritive compounds that are found in many foods. Phytochemicals are functional foods that have health benefits beyond basic nutrition, and are health promoting compounds that come from plant sources. “Phytochemicals” and “Phytonutrients” refers to any chemical produced by a plant that imparts one or more health benefit on the user. Non-limiting examples of phytochemicals and phytonutrients include those that are:

i) phenolic compounds which include monophenols (such as, for example, apiole, carnosol, carvacrol, dillapiole, rosemarinol); flavonoids (polyphenols) including flavonols (such as, for example, quercetin, fingerol, kaempferol, myricetin, rutin, isorhamnetin), flavanones (such as, for example, fesperidin, naringenin, silybin, eriodictyol), flavones (such as, for example, apigenin, tangeritin, luteolin), flavan-3-ols (such as, for example, catechins, (+)-catechin, (+)-gallocatechin, (−)-epicatechin, (−)-epigallocatechin, (−)-epigallocatechin gallate (EGCG), (−)-epicatechin 3-gallate, theaflavin, theaflavin-3-gallate, theaflavin-3′-gallate, theaflavin-3,3′-digallate, thearubigins), anthocyanins (flavonals) and anthocyanidins (such as, for example, pelargonidin, peonidin, cyanidin, delphinidin, malvidin, petunidin), isoflavones (phytoestrogens) (such as, for example, daidzein (formononetin), genistein (biochanin A), glycitein), dihydroflavonols, chalcones, coumestans (phytoestrogens), and Coumestrol; Phenolic acids (such as: Ellagic acid, Gallic acid, Tannic acid, Vanillin, curcumin); hydroxycinnamic acids (such as, for example, caffeic acid, chlorogenic acid, cinnamic acid, ferulic acid, coumarin); lignans (phytoestrogens), silymarin, secoisolariciresinol, pinoresinol and lariciresinol); tyrosol esters (such as, for example, tyrosol, hydroxytyrosol, oleocanthal, oleuropein); stilbenoids (such as, for example, resveratrol, pterostilbene, piceatannol) and punicalagins;

ii) terpenes (isoprenoids) which include carotenoids (tetraterpenoids) including carotenes (such as, for example, α-carotene, β-carotene, γ-carotene, δ-carotene, lycopene, neurosporene, phytofluene, phytoene), and xanthophylls (such as, for example, canthaxanthin, cryptoxanthin, aeaxanthin, astaxanthin, lutein, rubixanthin); monoterpenes (such as, for example, limonene, perillyl alcohol); saponins; lipids including: phytosterols (such as, for example, campesterol, beta sitosterol, gamma sitosterol, stigmasterol), tocopherols (vitamin E), and ω-3, -6, and -9 fatty acids (such as, for example, gamma-linolenic acid); triterpenoid (such as, for example, oleanolic acid, ursolic acid, betulinic acid, moronic acid);

iii) betalains which include Betacyanins (such as: betanin, isobetanin, probetanin, neobetanin); and betaxanthins (non glycosidic versions) (such as, for example, indicaxanthin, and vulgaxanthin);

iv) organosulfides, which include, for example, dithiolthiones (isothiocyanates) (such as, for example, sulphoraphane); and thiosulphonates (allium compounds) (such as, for example, allyl methyl trisulfide, and diallyl sulfide), indoles, glucosinolates, which include, for example, indole-3-carbinol; sulforaphane; 3,3′-diindolylmethane; sinigrin; allicin; alliin; allyl isothiocyanate; piperine; syn-propanethial-S-oxide;

v) protein inhibitors, which include, for example, protease inhibitors;

vi) other organic acids which include oxalic acid, phytic acid (inositol hexaphosphate); tartaric acid; and anacardic acid; or

vii) combinations thereof.

As used herein, a “prebiotic” is a food substance that selectively promotes the growth of beneficial bacteria or inhibits the growth or mucosal adhesion of pathogenic bacteria in the intestines. They are not inactivated in the stomach and/or upper intestine or absorbed in the gastrointestinal tract of the person ingesting them, but they are fermented by the gastrointestinal microflora and/or by probiotics. Prebiotics are, for example, defined by Glenn R. Gibson and Marcel B. Roberfroid, “Dietary Modulation of the Human Colonic Microbiota: Introducing the Concept of Prebiotics,” J. Nutr. 1995 125: 1401-1412. Non-limiting examples of prebiotics include acacia gum, alpha glucan, arabinogalactans, beta glucan, dextrans, fructooligosaccharides, fucosyllactose, galactooligosaccharides, galactomannans, gentiooligosaccharides, glucooligosaccharides, guar gum, inulin, isomaltooligosaccharides, lactoneotetraose, lactosucrose, lactulose, levan, maltodextrins, milk oligosaccharides, partially hydrolyzed guar gum, pecticoligosaccharides, resistant starches, retrograded starch, sialooligosaccharides, sialyllactose, soyoligosaccharides, sugar alcohols, xylooligosaccharides, or their hydrolysates, or combinations thereof.

As used herein, probiotic micro-organisms (hereinafter “probiotics”) are food-grade microorganisms (alive, including semi-viable or weakened, and/or non-replicating), metabolites, microbial cell preparations or components of microbial cells that could confer health benefits on the host when administered in adequate amounts, more specifically, that beneficially affect a host by improving its intestinal microbial balance, leading to effects on the health or well-being of the host. See, Salminen S, Ouwehand A. Benno Y. et al., “Probiotics: how should they be defined?,” Trends Food Sci. Technol., 1999:10, 107-10. In general, it is believed that these micro-organisms inhibit or influence the growth and/or metabolism of pathogenic bacteria in the intestinal tract. The probiotics may also activate the immune function of the host. For this reason, there have been many different approaches to include probiotics into food products. Non-limiting examples of probiotics include Aerococcus, Aspergillus, Bacillus, Bacteroides, Bifidobacterium, Candida, Clostridium, Debaromyces, Enterococcus, Fusobacterium, Lactobacillus, Lactococcus, Leuconostoc, Melissococcus, Micrococcus, Mucor, Oenococcus, Pediococcus, Penicillium, Peptostrepococcus, Pichia, Propionibacterium, Pseudocatenulatum, Rhizopus, Saccharomyces, Staphylococcus, Streptococcus, Torulopsis, Weissella, or combinations thereof.

The terms “protein,” “peptide,” “oligopeptides” or “polypeptide,” as used herein, are understood to refer to any composition that includes, a single amino acids (monomers), two or more amino acids joined together by a peptide bond (dipeptide, tripeptide, or polypeptide), collagen, precursor, homolog, analog, mimetic, salt, prodrug, metabolite, or fragment thereof or combinations thereof. For the sake of clarity, the use of any of the above terms is interchangeable unless otherwise specified. It will be appreciated that polypeptides (or peptides or proteins or oligopeptides) often contain amino acids other than the 20 amino acids commonly referred to as the 20 naturally occurring amino acids, and that many amino acids, including the terminal amino acids, may be modified in a given polypeptide, either by natural processes such as glycosylation and other post-translational modifications, or by chemical modification techniques which are well known in the art. Among the known modifications which may be present in polypeptides of the present invention include, but are not limited to, acetylation, acylation, ADP-ribosylation, amidation, covalent attachment of a flavanoid or a heme moiety, covalent attachment of a polynucleotide or polynucleotide derivative, covalent attachment of a lipid or lipid derivative, covalent attachment of phosphatidylinositol, cross-linking, cyclization, disulfide bond formation, demethylation, formation of covalent cross-links, formation of cystine, formation of pyroglutamate, formylation, gamma-carboxylation, glycation, glycosylation, glycosylphosphatidyl inositol (“GPI”) membrane anchor formation, hydroxylation, iodination, methylation, myristoylation, oxidation, proteolytic processing, phosphorylation, prenylation, racemization, selenoylation, sulfation, transfer-RNA mediated addition of amino acids to polypeptides such as arginylation, and ubiquitination. The term “protein” also includes “artificial proteins” which refers to linear or non-linear polypeptides, consisting of alternating repeats of a peptide.

Non-limiting examples of proteins include dairy based proteins, plant based proteins, animal based proteins and artificial proteins. Dairy based proteins include, for example, casein, caseinates (e.g., all forms including sodium, calcium, potassium caseinates), casein hydrolysates, whey (e.g., all forms including concentrate, isolate, demineralized), whey hydrolysates, milk protein concentrate, and milk protein isolate. Plant based proteins include, for example, soy protein (e.g., all forms including concentrate and isolate), pea protein (e.g., all forms including concentrate and isolate), canola protein (e.g., all forms including concentrate and isolate), other plant proteins that commercially are wheat and fractionated wheat proteins, corn and its fractions including zein, rice, oat, potato, peanut, green pea powder, green bean powder, and any proteins derived from beans, lentils, and pulses. Animal based proteins may be selected from the group consisting of beef, poultry, fish, lamb, seafood, or combinations thereof.

As used herein, the term “shelf-stable” means capable of being stored at room temperature (e.g., about 20° C. to about 25° C.) for long periods (e.g., more than 3 months) without becoming spoiled or rotten. Typical dairy based nutritional compositions normally need to be stored refrigerated, but the shelf-stable dairy based compositions in embodiments of the present disclosure have been processed so that they can be safely stored in a sealed container at room or ambient temperature for a usefully long shelf life without unacceptably changing their taste or texture. The dairy based nutritional compositions produced can be shelf-stable, for example, for more than 3 months, 6 months, 9 months, 12 months, 18 months, etc.

As used herein, “snack” food product(s) refers to one or more food products that are typically smaller in portion size than a meal food product and/or are intended to be consumed between normal meals of breakfast, lunch and dinner.

As used herein, a “synbiotic” is a supplement that contains both a prebiotic and a probiotic that work together to improve the microflora of the intestine.

As used herein, the phrase “texture attributes” refer to attributes or descriptive characteristics relating to the texture of a food product. Texture attributes may include, but are not limited to, amount of pieces in matrix, surface roughness, firmness, moistness, breakdown, cohesiveness of the mass, adhesiveness of the mass, moisture absorption, number of manipulations (to prepare to swallow), ease of swallow, residual mouthcoating, denseness, fracturability, and roughness of the mass. In an embodiment, the texture attributes of amount of pieces in matrix, surface roughness and number of manipulations (to prepare to swallow) may all be measured using the Tongue to Palate Method, as will be described herein below. In another embodiment, the texture attributes of denseness, fracturability and roughness of the mass may all be measured using the Chewing Method, as will be described herein below. Many of the above-mentioned texture attributes may also be measured using both the Tongue to Palate Method of evaluation as well as the Chewing Method. For example, an In an embodiment, firmness, moistness, moisture absorption, breakdown, cohesiveness of the mass, adhesiveness of the mass, ease of swallow, and residual mouthcoating are all examples of texture attributes that may be measured according to either or both of the Tongue to Palate Method or the Chewing Method.

As used herein, “Tongue to Palate Method” refers to a method of evaluating a food product comprising compressing and manipulating a food sample with the tongue against the hard palate. The primary parameters assessed in the Tongue to Palate Method include, but are not limited to, initial tongue manipulation, first compression with tongue to palate, manipulation of the sample 5-7 times with the tongue against the palate, and number of manipulations with the tongue.

As used herein the term “vitamin” is understood to include any of various fat-soluble or water-soluble organic substances (non-limiting examples include vitamin A, Vitamin B1 (thiamine), Vitamin B2 (riboflavin), Vitamin B3 (niacin or niacinamide), Vitamin B5 (pantothenic acid), Vitamin B6 (pyridoxine, pyridoxal, or pyridoxamine, or pyridoxine hydrochloride), Vitamin B7 (biotin), Vitamin B9 (folic acid), and Vitamin B12 (various cobalamins; commonly cyanocobalamin in vitamin supplements), vitamin C, vitamin D, vitamin E, vitamin K, folic acid and biotin) essential in minute amounts for normal growth and activity of the body and obtained naturally from plant and animal foods or synthetically made, pro-vitamins, derivatives, analogs.

Components of Nutritional Compositions

The present disclosure provides acidified dairy based nutritional compositions with a thick texture that are shelf stable at ambient temperatures and methods of making the same through direct acidification of a dairy based composition using specially prepared fruit or flavor preparations. The shelf stable dairy based nutritional compositions have an enhanced thick texture that is pleasing to the consumer. In an embodiment, the thick texture is appealing to babies and toddlers. As a child consumes the composition the texture attributes of the composition will be experienced, allowing the child to discover new food textures. This discovery is helpful for young children just learning to self-feed.

There are many refrigerated food products currently on the market. Refrigeration is the process of cooling or freezing the food product to lower temperatures so as to extend the life of the food product. During storage, bacteria within food products can cause the food product to spoil over time. By refrigerating, a food product can be maintained without spoiling for extended periods of time such as weeks or months. Typical food products requiring refrigeration include meat and dairy products. They are generally more costly to store than non-refrigerated foods due to the energy costs associated with refrigeration or freezing. Providing foods that are shelf stable at ambient temperatures allows for lower prices to be set and also increases convenience for consumers.

Shelf-stable foods are foods that would normally be stored refrigerated but have been processed so that they can be safely stored at room or ambient temperature for long shelf life. Various food preservation and packaging techniques are used to extend a food's shelf life. Some of these techniques include decreasing the amount of available water in a food product, increasing its acidity, or irradiating or otherwise sterilizing the food product and then sealing it in an air-tight container. For some foods alternative ingredients can be used. In an embodiment, shelf stable acidified dairy based compositions are provided. In an embodiment, the compositions are shelf stable for up to 12 months.

Compositions of the present disclosure may also include micro and macronutrients specifically tailored to meet the health needs of child consumers at various ages or developmental stages. The compositions are suited for caregivers seeking to balance what is nutritionally appropriate for a baby or young child's health with the types of foods that are appealing in taste and texture to children of that age and in that particular developmental stage. As noted above, child development may be divided into certain developmental stages based on the behaviors and capabilities typically achieved at a certain age. The stages are identified and described in Table 1.

TABLE 1
Developmental Milestones/Stages

| | Birth+ | Supported Sitter | Sitter |
|---|---|---|---|
| | (e.g., 0-4 mos.) | (e.g., 4-6 mos.) | (e.g., 6+ mos.) |
| Gross Motor | Little truncal (vertical) | Controls the head | Sits independently |
| Development | stability | Truncal stability to sit with | Truncal stability |
| | | support | |
| Fine Motor | Reflexive grasp only | Sustained voluntary grasp | Primitive squeeze/Palmar |
| Development | | | grasp |
| | | | Begins to rake (with |
| | | | fingers) food toward self |
| Oral Motor | Rooting and sucking | Moves pureed food | Develops tongue wave and |
| Development | Early gag reflex | forward and back with | lip close |
| | | tongue to swallow | Begins chewing movements |
| | | Loss of extrusor reflex | using up and down movement |
| | | (tongue thrust) | of jaw (“munching”) |
| | | Gag reflex locus moves | Uses upper lip to help clear |
| | | from the mid portion to the | food off of spoon |
| | | posterior of the tongue | Able to keep thicker purees in |
| | | | mouth |
| | | | Can drink from a cup with help |
| Cognitive | Enjoys bold colors | Indicates an appetite for | Reaches for food or spoon when |
| Development | Prefers looking at people | satiety | hungry |
| | Smiles, frowns, grimaces | Moves head forward to | Slows down eating when full |
| | | reach spoon when hungry | Clenches mouth shut when full |
| | | or away when full | |

| | Crawler | Toddler | Preschooler |
|---|---|---|---|
| | (e.g., 8+ mos.) | (e.g., 12+ mos.) | (e.g., 24+ mos.) |
| Gross Motor | Crawls with stomach off | Stands alone | Runs well without falling |
| Development | the floor | Walks with and without | Sits in a booster seat or |
| | May pull self to stand | support | at table |
| | Struggles to get object out | | |
| | of reach | | |
| Fine Motor | Begins to self-feed Finger | Feeds self easily with | Manipulates small |
| Development | Foods as pincer grasp is | fingers | objects |
| | developing | Fine Pincer Grasp | Practicing/mastering |
| | Begins to manipulate | developed | utensils |
| | objects correctly (spoon) | Begins to use spoon and | Eats/drinks with minimal |
| | but does not use it for self | fork | spilling |
| | feeding yet | | Holds and drinks from a cup |
| | Explores objects with | | |
| | hands and mouth | | |
| | Can hold lidded up | | |
| | indepen | | |
| Oral Motor | Developing tongue | Able to drink from a cup | Refined drinking skills |
| Development | lateralization used to move | or straw | Chews skillfully and |
| | food to jaw line for mashing | Skillful at chewing of | efficiently |
| | and chewing | complex foods | Needs less time and |
| | Begins to use jaw to mash | Bites through a variety of | fewer chews to finish a |
| | and chew food | textures | mouth full of food |
| | Begins to track and sort | Coordinated tongue | Molars present |
| | pieces of food in the mouth | movement | Uses tongue to clear food |
| | | First year molars begin | from lips |
| | | erupting | |
| Cognitive | Reaches for food when | Rejection of new foods | Follows simple instructions |
| Development | hungry | Expresses desire for | Begins to sort by shape |
| | Shows excitement for food | specific foods | and color |
| | when hungry | Follows one step | Growing independence |
| | Shakes head to say “no | commands | Cautious about new foods |
| | more” when full | Plays with food and | Prefers familiar foods |
| | | throws it when full | |
| | | Uses words like “all | |
| | | done” | |
| | | Can lead parent by | |
| | | pointing | |

Each developmental stage also has specific nutritional requirements. Products intended for a child at a certain developmental stage may be distinct from those designed for consumption at other stages. In an embodiment, the present compositions meet the nutritional requirements for a child in different ages or developmental stages as well as provided a product with a taste and texture that would be appealing to a child at that age or development stage. For example, a presently disclosed composition meets the nutritional requirements for a child 12-18 months old, at the toddler developmental stage. It also has taste and texture characteristics appealing to a child of that age. In another embodiment, the composition meets the nutritional requirements for a child up to 36 months of age—through the preschooler developmental stage.

The present nutritional compositions include at least two components; the pH neutral dairy based component and the low pH flavor preparation. These components have lower viscosities. However, upon combination, the mixture of the components yields a composition with a higher viscosity than that of either of the components, allowing thicker textures to be achieved. The skilled artisan will appreciate that the nutritional compositions are not limited to solely the two described components and that numerous other ingredients may be included.

The presently disclosed nutritional compositions also have the nutrients required to support children's growth. In an embodiment, the compositions support healthy growth and development through the natural goodness of milk. Also In an embodiment, the nutritional compositions provide calcium, magnesium and zinc for the growth generally as well as for the development of strong bones and teeth. In an embodiment, two servings of 60 grams of the nutritional compositions provide 45% of babies' daily calcium, magnesium and zinc needs.

As noted above, the nutritional compositions are dairy based compositions. The dairy based compositions are pH neutral. Dairy based compositions either include ingredients made from milk, or ingredients made from a milk substitute. Various embodiments of the nutritional composition are able to be consumed by those with lactose intolerance or other aversions to certain milk products. The nutritional compositions may be prepared with either fermented dairy based products or with non-fermented dairy based products. The skilled artisan will appreciate that any dairy based product may be used in the compositions.

In an embodiment, non-fermented dairy based products are used. These may include cow's milk, sheep's milk, goat's milk, non-fermented cheese, cream, butter, cream, as well as other products made from the different milks, etc.

Dairy-like products (dairy-substitutes) may also be incorporated into the nutritional compositions. In an embodiment, the compositions include at least one of rice milk, soy milk, coconut milk, almond milk, nut milk, etc.

In an embodiment, the dairy based composition includes milk, sugar, starch and hydrocolloids.

The dairy based composition may be heat treated as well.

The present nutritional compositions also include a flavor preparation that is a fruit preparation. The flavor preparation is a low pH preparation. The preparation may be made from any edible fruit. Non-limiting examples include apple, banana, mango, orange, tangerine, tangelo, grapefruit, lemon, lime, grape, passionfruit, cherry, berry, raspberry, blackberry, boysenberry, mulberry, strawberry, blueberry, goji berry, currant, acai, peach, nectarine, plum, apricot pineapple, guava, kiwi, cherimoya, kumquat, lychee, pitaya, jackfruit, melon, pear, mangosteen, pomegranate, etc. In an embodiment, the fruit preparation is peach raspberry. In another embodiment, it is mango. The natural fruits are healthful additions to the diet of both adults and young children.

Other low pH flavor preparations may be used in the composition as well. Either in place of, or in addition to the fruit preparation, the nutritional composition could be flavored as vanilla, chocolate, coffee, caramel, butterscotch, mint, spice, nut, ginger, cinnamon, etc. The skilled artisan will appreciate that a variety of flavors may be appealing to a consumer. The skilled artisan will also appreciate that a plain flavored nutritional composition can be made.

The various flavors will allow a child consumer just beginning to self feed to appreciates new tastes and improve their palates while still allowing the child to receive the right balance of nutrients and vitamins that a baby or young child requires at the development stage that corresponds to the child's current age.

The fruit/flavor preparation lends appealing and appetizing flavors to the nutritional composition. It also has a functional purpose in that the addition of the low pH fruit/flavor preparation to the pH neutral dairy based composition triggers thickening of the product; allowing ideal texture attributes to be achieved. The dairy based composition is directly acidified by the addition of the low pH fruit preparation to the dairy based composition.

In an embodiment, the fruit/flavor preparation contains fruit, sugar, hydrocolloids, and organic acid. The fruit/flavor preparation may also be pasteurized or aseptic.

Other ingredients may be included as appropriate to satisfy the nutritional needs of the target consumer. For example, additional nutrients to support children's growth at various developmental stages may be included as appropriate. When children age above 12 months, parents and caregivers often begin to look for foods to transition children away from traditional baby foods. However, at age 12 months, babies still have specific nutritional needs. In an embodiment, the nutritional compositions provide macronutrients and micronutrients appropriate for children ranging in age from 6 to 36 months of age. In another embodiment, the nutritional compositions provide necessary macronutrients and micronutrients for children 12 to 36 months in age. The compositions may also be appropriate for children aged 12 to 18 months. The compositions help to supply the nutritional needs for children at the relevant developmental stage.

The present nutritional compositions may also include other beneficial or functional ingredients. For example, the nutritional compositions may include a source of protein. The protein source may be dietary protein including, but not limited to animal protein (such as meat protein or egg protein), dairy protein (such as casein, caseinates (e.g., all forms including sodium, calcium, potassium caseinates), casein hydrolysates, whey (e.g., all forms including concentrate, isolate, demineralized), whey hydrolysates, milk protein concentrate, and milk protein isolate)), vegetable protein (such as soy protein, wheat protein, rice protein, and pea protein), or combinations thereof. In an embodiment, the protein source is selected from the group consisting of whey, chicken, corn, caseinate, wheat, flax, soy, carob, pea, or combinations thereof.

In an embodiment, the nutritional compositions have lower protein content tailored to meet the nutritional needs of children at the appropriate developmental stage than dairy based products not so tailored.

In an embodiment, the nutritional compositions further include one or more prebiotics. The prebiotics may be selected from the group consisting of acacia gum, alpha glucan, arabinogalactans, beta glucan, dextrans, fructooligosaccharides, galactooligosaccharides, galactomannans, gentiooligosaccharides, glucooligosaccharides, guar gum, inulin, isomaltooligosaccharides, lactosucrose, lactulose, levan, maltodextrins, partially hydrolyzed guar gum, pecticoligosaccharides, retrograded starch, soyoligosaccharides, sugar alcohols, xylooligosaccharides, or combinations thereof.

In an embodiment, the nutritional compositions further include one or more probiotics selected from the group consisting of Aerococcus, Aspergillus, Bacteroides, Bifidobacterium, Candida, Clostridium, Debaromyces, Enterococcus, Fusobacterium, Lactobacillus, Lactococcus, Leuconostoc, Melissococcus, Micrococcus, Mucor, Oenococcus, Pediococcus, Penicillium, Peptostrepococcus, Pichia, Propionibacterium, Pseudocatenulatum, Rhizopus, Saccharomyces, Staphylococcus, Streptococcus, Torulopsis, Weissella, or combinations thereof.

The nutritional compositions may also include a source of fiber, fiber or a blend of different types of fiber. The fiber blend may contain a mixture of soluble and insoluble fibers. Soluble fibers may include, for example, fructooligosaccharides, acacia gum, inulin, etc. Insoluble fibers may include, for example, pea outer fiber.

In an embodiment, the nutritional compositions further include a source of carbohydrates. Any suitable carbohydrate may be used in the present nutritional compositions including, but not limited to, sucrose, lactose, glucose, fructose, corn syrup solids, maltodextrin, modified starch, amylose starch, tapioca starch, corn starch, or combinations thereof.

In an embodiment, the nutritional compositions further include a source of fat. The source of fat may include any suitable fat or fat mixture. For example, the fat may include, but is not limited to, vegetable fat (such as olive oil, corn oil, sunflower oil, rapeseed oil, hazelnut oil, soy oil, palm oil, coconut oil, canola oil, lecithins, and the like) and animal fats (such as milk fat).

In another embodiment, the nutritional composition further includes one or more amino acids. Non-limiting examples of amino acids include isoleucine, alanine, leucine, asparagine, lysine, aspartate, methionine, cysteine, phenylalanine, glutamate, threonine, glutamine, tryptophan, glycine, valine, proline, serine, tyrosine, arginine, citrulline, histidine, or combinations thereof.

In an embodiment, the nutritional composition further includes one or more synbiotics, phytonutrients and/or antioxidants. The antioxidants may be selected from the group consisting of carotenoids, coenzyme Q10 (“CoQ10”), flavonoids, glutathione, Goji (Wolfberry), hesperidin, Lactowolfberry, lignan, lutein, lycopene, polyphenols, selenium, vitamin A, vitamin B1, vitamin B6, vitamin B12, vitamin C, vitamin D, vitamin E, or combinations thereof.

In an embodiment, the nutritional composition further includes one or more vitamins and minerals. Non-limiting examples of vitamins include Vitamins A, B-complex (such as B-1, B-2, B-6 and B-12), C, D, E and K, niacin and acid vitamins such as pantothenic acid and folic acid, biotin, or combinations thereof. Non-limiting examples of minerals include calcium, iron, zinc, magnesium, iodine, copper, phosphorus, manganese, potassium, chromium, molybdenum, selenium, nickel, tin, silicon, vanadium, boron, or combinations thereof.

In an embodiment, the compositions may include a source of carbohydrate, a source of fat, canola oil, flaxseed oil, a source of omega-3 fatty acids, a source of protein, a source of fiber, a flavor, a color, a vegetable puree, vitamins, minerals, DHA, EPA, antioxidants, amino acids, fish oil, phytochemicals, probiotics, prebiotics, synbiotics, non-replicating microorganism, liquid whole grain, etc.

Other optional ingredients can be added to make the nutritional composition sufficiently palatable. For example, the nutritional compositions of the present disclosure can optionally include conventional food additives, such as any of, acidulants, additional thickeners, buffers or agents for pH adjustment, chelating agents, colorants, emulsifiers, excipients, flavor agents, minerals, osmotic agents, pharmaceutically acceptable carriers, preservatives, stabilizers, sugars, sweeteners, texturizers, or combinations thereof. The optional ingredients can be added in any suitable amount. In an embodiment, the compositions do not contain any artificial flavors, colors, or preservatives.

In an embodiment, the compositions are not fermented. In an embodiment, the nutritional compositions contain an edible acidulant such as organic acid. Non-limiting examples include lactic acid, malic acid, citric acid, calcium citrate, tartaric acid, phosphoric acid, glucono delta lactone, or combinations thereof. In an embodiment, solutions containing acidulants are incorporated into the composition. The solutions may be prepared with water. In an embodiment, a solution of 50% water and 50% citric acid is incorporated into the composition. The skilled artisan will appreciate that a variety of acidulants may be used in the disclosed compositions. In an embodiment, the fruit/flavor preparation contains the acidulant or acidulant solution.

As noted above, the dairy based composition may be pH neutral. The fruit/flavor preparation may have a low pH. The skilled artisan will appreciate that the fruit/flavor preparation may have any pH that will directly acidify the dairy based composition and yield a thick-textured nutritional composition.

The nutritional compositions may be slightly acidified. In an embodiment, the composition may have a pH ranging from 3.5 to 4.5. The composition may have a pH ranging from 4 to 4.5. The pH of the nutritional composition may also range from 3.8 to 4.2, or 3.9 to 4.1, or about 4.0. The skilled artisan will appreciate that the nutritional compositions may have any pH that is not unpleasant tasting for the consumer and still allows the thick texture to be maintained.

The nutritional compositions may contain low amounts of added sugar. In an embodiment, the compositions contain less sugar than traditional chilled dairy products. In an embodiment, the compositions contain no added sugar. Compositions with low sugar are beneficial to young children and babies that should not have large amounts of added sugar in their diets, as well as for people with diabetes, hypoglycemia, or otherwise have low-sugar dietary needs.

The nutritional compositions may further include elements to affect the texture, viscosity, and mouth feel of the product. In an embodiment, the low pH fruit/flavor preparation includes hydrocolloids such as pectin, gelatin, carrageenan, gelatin, guar gum, tapioca, starches, etc. In an embodiment, the dairy based composition includes hydrocolloids. The skilled artisan will appreciate that other hydrocolloids may be used in the compositions as well. In an embodiment, the composition includes texturizing agents or thickening agents (including modified starches) to allow a post-thickening effect.

Children in different developmental stages may also exhibit different preferred texture attributes and other key food related attributes. Children learning to self-feed may also find certain textures and attributes more pleasing than others. In an embodiment, the present compositions have an adapted texture to help babies and young children learn to self-feed. In an embodiment, the composition has a thick texture. The thicker texture facilitates self-feeding by helping young children be able to spoon and eat the compositions without assistance. In another embodiment the composition has a jellified texture. The compositions may have a smooth, homogenous texture. The compositions may have a texture similar to the textures available in chilled dairy products.

The dairy based nutritional compositions may be appealing to parents and caregivers of babies and young children in that, in an embodiment, the dairy based nutritional compositions have the proper balance of nutrients and vitamins that a baby or young child needs at each stage of development. The compositions also assist in progressing children's tastes and palates by introducing them to new tastes, textures and flavors.

Portion size is also important to developing compositions targeted for children's consumption at certain developmental stages. The portion size should be sufficiently large to supply the consumer with the necessary nutrients for the appropriate developmental stage, but should not be so large as to intimidate a consumer just beginning to learn to self-feed. In an embodiment, the compositions are of an appropriate portion size to help children start to eat alone and develop autonomy.

The skilled artisan will appreciate that the portion size is determined by the developmental stage of the child to be fed. The portion size may be appropriate for a whole meal, part of a meal, a snack, dessert, etc. In an embodiment, the compositions are a milk-based dessert. In an embodiment, the compositions are a part of a complete meal.

The nutritional compositions may be packaged in any type of packaging. The package may be structured to include logos, colors and designs to improve the marketability of the consumptions. In an embodiment, the packages are aesthetically appealing to children and their caregivers.

The packaging may include indicia to convey information regarding the compositions to consumers. The packages may include information explaining the age range that the compositions target. In an embodiment, the packages indicate that the compositions are intended for children 12 to 18 months old.

The packaging may also convey information regarding the nutrient profile of the nutritional compositions. In an embodiment, the packaging states that the compositions within are rich in calcium and iron for strong bones and teeth and for the building of healthy bones. The skilled artisan will appreciate that claims involving growth or other health claims may be included on the packaging. In an embodiment, the packaging contains claims directed to calcium, magnesium, and zinc content and health claims related to those nutrients.

The colors of the packaging may be indicative to aid in self-selection by the target consumers. A light yellow package may contain vanilla, a brown package chocolate, a red package raspberry, an orange package mango etc. The skilled artisan will appreciate that a variety of colors may be paired to various flavors. The packaging may also contain more than one flavor.

If the packaging contains nutritional compositions for young children, the skilled artisan will appreciate that the package will be shaped in such a way that a young child would be able to hold the package while self feeding. In an embodiment, the packaging is curved to fit a young child's hands such that the child can hold the packaging independently. Small packages may also be helpful for parents and caregivers when carrying the packages around. The skilled artisan will appreciate that the packaging for the dairy based nutritional compositions may also be targeted to appeal to other customers seeking such compositions.

Methods of Manufacturing Shelf Stable Dairy Based Nutritional Compositions.

In a general embodiment, a method of making an acidified dairy based nutritional composition is provided. In a general embodiment, the method comprises manufacturing a thick textured nutritional composition through direct acidification of the dairy based composition using a flavor preparation. In an embodiment, the nutritional composition is made by mixing a pH neutral dairy based composition with a low pH flavor preparation (either fruit or non-fruit based) to create an ambient, shelf-stable dairy based nutritional composition with a thick texture. The methods produce a nutritional composition with a new texture experience able to be adapted to the nutritional needs of the consumer target group. The skilled artisan will appreciate that the following methods may also be applicable to producing chilled dairy based compositions with a thickened texture as well as shelf stable dairy based nutritional compositions.

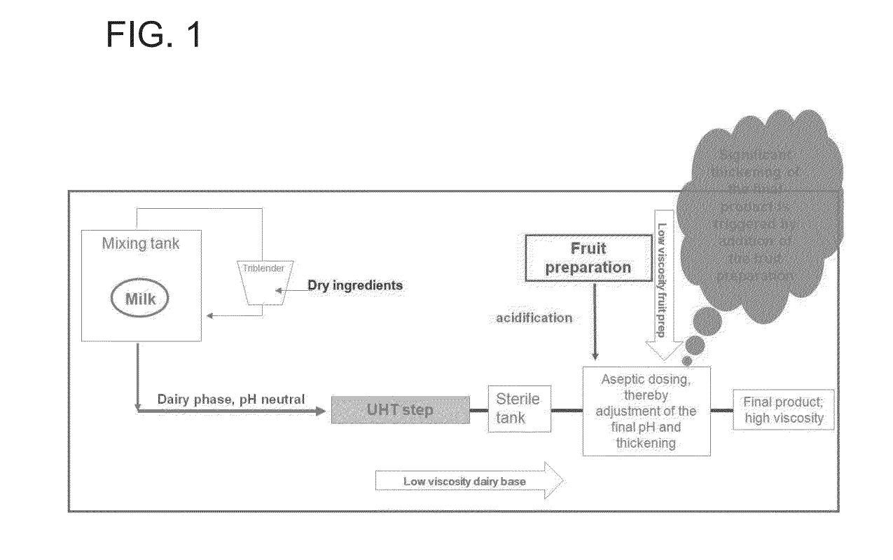

As illustrated in FIG. 1, a pH neutral dairy phase undergoes UHT (ultra high temperature) processing and sterilization, after which a low pH fruit/flavor preparation may be added to the dairy based composition as the final step before aseptic dosing and filling the packages or containers with the final dairy based nutritional composition having an adjusted pH and thickened texture. Applicant has found that the mixing of the dairy based composition and the fruit/flavor preparation triggers direct acidification of the composition, resulting in a thick textured nutritional composition. Post-thickening of the composition has also been found to occur after the composition has been placed into final packaging.

As is also illustrated in FIG. 1, in an embodiment, the acidification step occurs after heat treatment. In an embodiment, the acidification occurs at a cold temperature (under 10 degrees Celsius). In an embodiment, the acidification occurs at a cold temperature (under 30 degrees Celsius). During the aseptic dosing phase, the pH of the final nutritional composition is adjusted and the composition thickens. Post-thickening of the composition also occurs, yielding a high viscosity final product with a thick texture pleasing to consumers in a target market.

In an embodiment, the dairy based composition is directly acidified by the addition of the fruit preparation during continuous mixing of the composition to avoid a quick change in pH. The addition of the fruit/flavor composition may be made after cooling the composition. The mixing of the composition may occur in a storage tank, while filling a tank or other packaging, or as a separate step. The skilled artisan will appreciate that dynamic or static mixing may be used.

The method may also include pasteurization of the composition, thermisation, or hot filling. In an embodiment, the method includes hot filling of composition and post-setting in the final cup. In an embodiment, the hot filling occurs at a temperature between 40 and 100 degrees Celsius. In an embodiment, the hot filling occurs at a temperature between 50 and 80 degrees Celsius. The skilled artisan will appreciate that the post-setting effect may be supported by selected ingredients including hydrocolloids.

The dairy based composition may include hydrocolloids such as pectin, gelatin, guar gum, carrageenan, tapioca, starches, etc. The fruit preparation used in the composition may contain hydrocolloids as well. The skilled artisan will appreciate that a variety of hydrocolloids may be included in the dairy based composition and fruit preparation. A flavor preparation such a chocolate, caramel, coffee, spice, nut, etc. may be used along with, or in place of, the fruit preparation. The flavor preparation may also contain hydrocolloids. In an embodiment, the hydrocolloids in the fruit/flavor preparation and the dairy based composition interact to facilitate thickening of the final nutritional composition.

As noted above, the nutritional composition may include numerous additional ingredients such as emulsifiers, starches, vitamins, mineral, probiotics, prebiotics, sugars, proteins, fats, carbohydrates, etc. The skilled artisan will appreciate that these may be added to the nutritional composition as separate wet or dry ingredients, as part of the dairy based composition, or as part of the fruit/flavor preparation.

The methods may be used to produce new, high viscosity products on old manufacturing lines without requiring any changes to the lines. Mixing of a pH neutral dairy composition and the low pH fruit/flavor preparation containing selected hydrocolloids is performed just before filling the final nutritional composition into packaging; triggering a thickening of the product after mixing and post-thickening after placement in the final package. The skilled artisan will appreciate that any type of the dairy based composition may be used.

The fruit/flavor preparation and dairy based composition both have a low viscosity. However, the final nutritional composition produced by the disclosed methods has a higher viscosity than either of the subcomponents as well as a desirably thick texture. The disclosed methods of producing the thick, shelf stable, dairy based nutritional compositions allow for delayed viscosity build-up in the production process, thus allowing for high viscosity products to be produced on the same lines as lower viscosity products. The methods allow thick nutritional compositions to be made while staying below given pressure limits of a manufacturing line through the delayed viscosity build-up. The methods provide the possibility of manufacturing highly viscous products while minimizing technical changes (including investment) in existing manufacturing lines, as existing manufacturing lines may have limited capability to handle highly viscous products up to the filling step. Leveraging post-thickening effect in the final product avoids the capability restrictions. In an embodiment, no changes need to be made to existing manufacturing lines in order to practice the disclosed methods.

The disclosed direct acidification methods also allow production time and cost to be saved as compared to acidification by fermentation.

Additionally, the thick texture able to be achieved in the nutritional compositions produced by the disclosed methods can be made similar to that of high viscosity dairy products such as curd, while still maintaining a distinct nutritional profile. For example, the presently disclosed composition may have a lower protein content than a traditional similarly textured dairy based product not produced using the present methods. In an embodiment, the nutritional compositions produced by the presently disclosed methods have a thick texture, but also meet the nutritional requirements of babies and toddlers from 6 to 36 months of age. In an embodiment, the method is used to produce compositions meeting the nutritional requirements of children 12 to 18 months of age.

In an embodiment, the method may be used to produce thick texture, dairy based products with low acidity (high pH) as well.

Without being bound to any theory, Applicant believes that the thickening effect achieved by the combination of the dairy based composition and the fruit preparation may be trigged by direct acidification of the dairy based composition by the fruit preparation and carry-over/synergisms of hydrocolloids from the dairy based composition and the fruit/flavor preparation.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method of making a thick textured dairy based nutritional composition, the method comprising the steps of:
providing a high pH dairy based composition;
providing a low pH preparation;
mixing the dairy based composition and the preparation, causing a thickening of the composition;
depositing the composition into packaging; and
allowing post-thickening of the composition to occur,
wherein the dairy based composition and the preparation have lower viscosities than the viscosity of the final thickened nutritional composition, and
wherein the nutritional composition is thickened to a texture pleasing to children of about 6 to 36 months of age.

2. The method according to claim 1, wherein the dairy based composition is acidified after a heat treatment.

3. The method according to claim 1, wherein the dairy based composition contains hydrocolloids.

4. The method according to claim 1, wherein the preparation is a fruit preparation including at least one fruit component selected from the group consisting of apple, banana, mango, orange, tangerine, tangelo, grapefruit, lemon, lime, grape, passionfruit, cherry, berry, raspberry, blackberry, boysenberry, mulberry, strawberry, blueberry, goji berry, currant, acai, peach, nectarine, plum, apricot pineapple, guava, kiwi, cherimoya, kumquat, lychee, pitaya, jackfruit, melon, pear, mangosteen, pomegranate, and combinations thereof.

5. The method according to claim 1, wherein the preparation is a non-fruit flavor preparation including at least one flavor component selected from the group consisting of vanilla, chocolate, coffee, caramel, butterscotch, mint, spice, nut, ginger, cinnamon, and combinations thereof.

6. The method according to claim 1, wherein acidification of the dairy based composition occurs through continuous mixing of the dairy based composition and the preparation.

7. The method according to claim 1, wherein the nutritional composition comprises a protein content tailored to the nutritional needs of babies and toddlers.

8. The method according to claim 1, wherein the mixing occurs at a low temperature.

9. The method according to claim 1, wherein the method further comprises hot filling the nutritional composition at a temperature ranging from about 50° to about 80° C.

10. A method of providing nutrition to young children, the method comprising the steps of:
producing a nutritional product using a method selected from the group consisting of those claimed in claim 1 to claim 9; and
marketing the nutritional product for ingestion by a target market comprising young children.

11. The method according to claim 10, wherein the target market are children at a developmental stage selected from the group consisting of supported sitter, sitter, crawler, toddler, preschooler and combinations thereof.

12. The method according to claim 10, wherein ingestion of the nutritional composition marketed to the target market comprising young children exposes the target market to new textures and flavors.

13. The method according to claim 10, wherein the method further comprises providing the nutritional composition to a child as a meal.

14. The method according to claim 10, wherein the method further comprises providing the nutritional composition to a child as a snack.

15. The method according to claim 10, wherein the method further comprises providing the nutritional composition to a child as a dessert.

16. A dairy based nutritional composition comprising:
a nutritional product using a method selected from the group consisting of those claimed in claim 1 to claim 9.

17. The dairy based nutritional composition according to claim 16, wherein the nutritional composition is a low acidity (high pH) composition.

18. The dairy based nutritional composition according to claim 16, wherein the nutritional composition further comprises a lower protein content than standard chilled dairy products.

19. The dairy based nutritional composition according to claim 16, wherein the nutritional composition has a smooth, homogenous texture.

20. The dairy based nutritional composition according to claim 16, wherein the nutritional composition is shelf stable.
